(19) United States
(12) Patent Application Publication
(10) Pub. No.: US 2015/0263578 A1
(43) Pub. Date: Sep. 17, 2015

(54) INTEGRAL SLOT LINER FOR MULTI-LAYER ELECTRIC MACHINES

(71) Applicant: GM GLOBAL TECHNOLOGY OPERATIONS LLC, Detroit, MI (US)

(72) Inventors: Steven Lee Hayslett, Troy, MI (US); Matthew D. Laba, Oakland, MI (US)

(73) Assignee: GM GLOBAL TECHNOLOGY OPERATIONS LLC, Detroit, MI (US)

(21) Appl. No.: 14/204,144

(22) Filed: Mar. 11, 2014

(51) Int. Cl. H02K 3/34

(52) U.S. Cl. CPC H02K 3/345

(57) ABSTRACT

A slot liner is configured for insertion into a slot of an electric machine. The slot liner is an integral piece configured to be folded along a first set of fold lines to define a plurality of liner segments in a folded configuration. The liner segments include first, second, third, fourth and fifth liner segments. The first and second liner segments are configured to be substantially parallel to one another in the folded configuration. The third and fourth liner segments are configured to be substantially parallel to one another in the folded configuration. The fifth liner segment extends between the third and fourth liner segments. The fifth liner segment is configured to be folded along a second set of fold lines to define a plurality of openings, including a first opening.

### TECHNICAL FIELD

The disclosure relates generally to an integral slot liner configured for insertion into a slot of an electric machine and an electric machine having the same.

### BACKGROUND

Electric machines or motors include stator assemblies which have conductors for the motor. In a bar wound stator assembly, the conductors are solid copper bars individually threaded into a stator stack. Following threading of the conductors in the stator stack, the conductors are individually twisted into the required positions. The conductors must be electrically isolated from the stator stack to prevent phase-to-ground shorts, and from one another to prevent phase-to-phase shorts from occurring. Slot liners are used to electrically isolate the conductors from the stator stack and from one another. The slot liners are typically composed of multiple separate pieces that are attached together.

### SUMMARY

A slot liner is configured for insertion into a slot. The slot liner is an integral piece configured to be folded along a first set of fold lines to define a plurality of liner segments in a folded configuration. The liner segments include first, second, third, fourth and fifth liner segments. The first and second liner segments are configured to be substantially parallel to one another in the folded configuration. The third and fourth liner segments are configured to be substantially parallel to one another in the folded configuration. The fifth liner segment extends between the third and fourth liner segments. The fifth liner segment is configured to be folded along a second set of fold lines to define a plurality of openings, including a first opening.

The third and fourth liner segments are contiguous with the first and second liner segments, respectively. The third and fourth liner segments are configured to be substantially perpendicular to the first and second liner segments, respectively, in the folded configuration.

The slot liner may be inserted into a slot of an electric machine. The slot may extend through a stator stack of the electric machine. The slot includes first, second and third slot walls. The first and second slot walls are configured to be substantially parallel to one another. The first opening is insulated from the first slot wall by only the first liner segment. The first opening is insulated from the second slot wall by the second and fifth liner segments.

The first and second liner segments are configured to extend substantially parallel to or along the first and second slot walls, respectively. The third liner segment is configured to extend substantially parallel to or along the third slot wall. The plurality of openings may include a second opening adjacent to the first opening. The second opening is insulated from the first slot wall by the first and fifth liner segments. The second opening is insulated from the second slot wall by only the second liner segment.

The plurality of openings may include a third opening adjacent to the second opening. The third opening is insulated from the first slot wall by only the first liner segment. The third opening is insulated from the second slot wall by the second and fifth liner segments. The plurality of openings may include a fourth opening adjacent to the third opening. The fourth opening is insulated from the first slot wall by the first and fifth liner segments. The fourth opening is insulated from the second slot wall by only the second liner segment.

A plurality of conductors is configured to be respectively inserted in the plurality of openings. Each of the conductors is configured to be twisted to define respective inwardly curved portions. Adjacent ones of the respective plurality of conductors are configured to be twisted in substantially opposite directions. The respective inwardly curved portions of the respective plurality of conductors are configured to face at least two of the plurality of liner segments. This configuration increases the robustness or strength of the slot liner, preventing tearing of the slot liner when the conductors are pulled towards the slot liner. Additionally, the configuration allows for a reduced thickness of the slot liner to be employed. In one example, the thickness of each of the plurality of liner segments may be reduced by approximately 50%, from approximately 0.2 mm to approximately 0.1 mm.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective partially cut-away view of an integral slot liner in a folded configuration;

FIG. 2 is a schematic plan view of the slot liner of FIG. 1 in an unfolded configuration;

FIG. 3 is a schematic sectional view of the slot liner of FIG. 1 in a folded configuration and positioned in a slot;

FIG. 4 is a schematic fragmentary perspective view of a twist-side of a stator assembly of an electric machine;

FIG. 5 is an enlarged schematic illustration of the portion 5 of FIG. 4.

### DETAILED DESCRIPTION

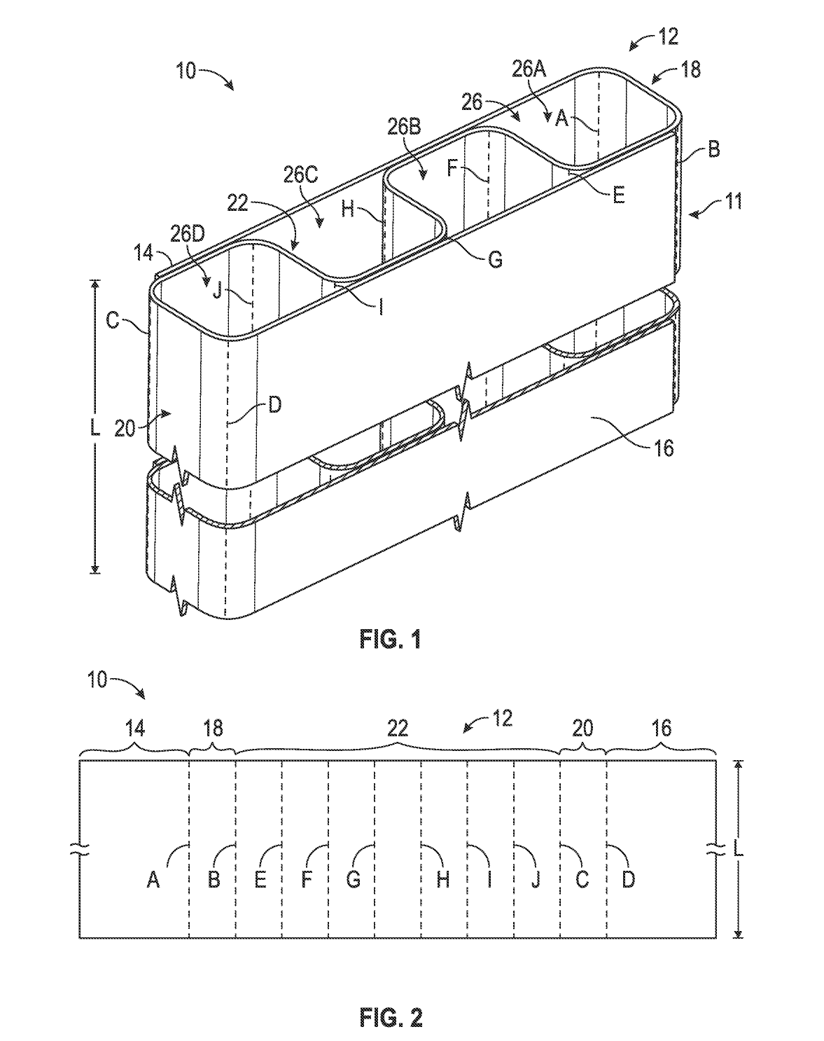

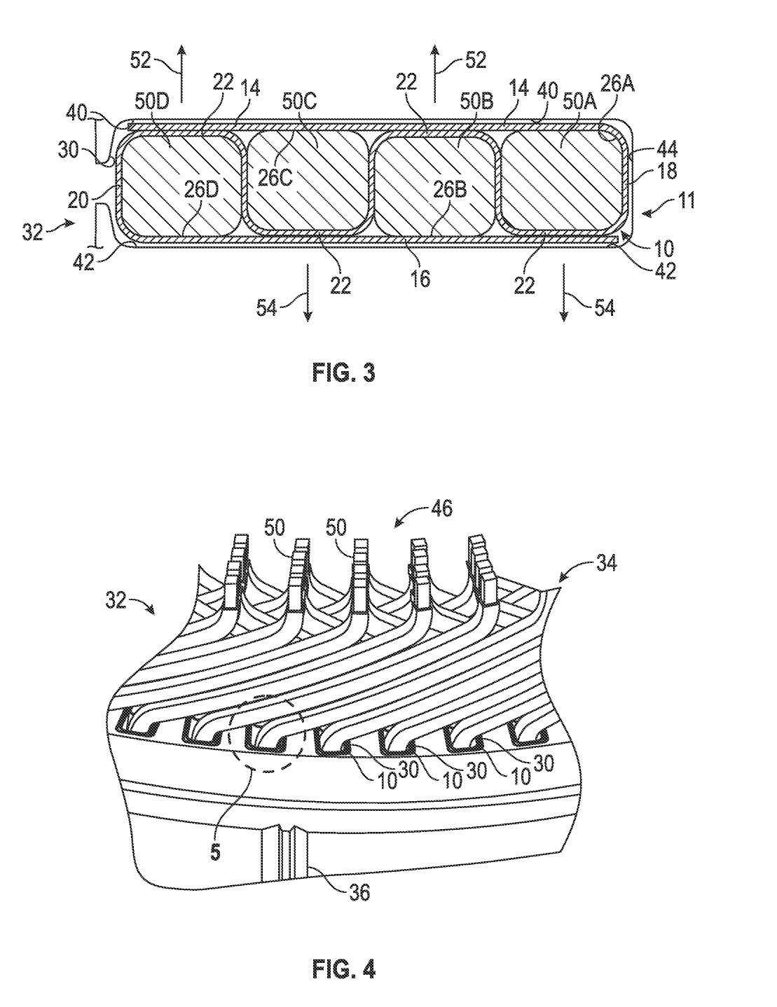

Referring to the Figures, wherein like reference numbers refer to the same or similar components throughout the several views, FIGS. 1-3 are schematic views of a slot liner 10. The slot liner 10 is an integral or single piece that is configured to be folded along a first set of fold lines to define a plurality of liner segments 12 in a folded configuration 11. FIGS. 1 and 3 shows the slot liner 10 in the folded configuration 11. FIG. 2 shows the slot liner 10 in an unfolded configuration. Referring to FIGS. 1-3, the liner segments 12 include first, second, third, fourth and fifth liner segments 14, 16, 18, 20 and 22.

In the embodiment shown in FIGS. 1-2, the first set of fold lines include first, second, third and fourth fold lines A-D. Any number of fold lines may be employed, depending on the requirements of the particular application. Referring to FIGS. 1 and 2, the slot liner 10 is configured to be folded along first and second fold lines A and B to define the third liner segment 18. The slot liner 10 is configured to be folded along third and fourth fold lines C and D to define the fourth liner segment 20.

Referring to FIGS. 1-3, the third liner segment 18 is contiguous with the first liner segment 14. The fourth liner segment 20 is contiguous with the second liner segment 16. The fifth liner segment 22 extends between the third and fourth liner segments 18, 20.

Referring to FIG. 1, the fifth liner segment 22 is configured to be folded along a second set of fold lines (such as fold lines E, F, G, H, I and J shown in FIGS. 1 and 2) to define a plurality of openings 26. Referring to FIGS. 1-2, the plurality of openings 26 include first, second, third and fourth openings 26A, 26B, 26C, 26D. Any number of fold lines for the fifth liner segment 22 or any number of openings 26 may be employed, depending on the particular application.

Referring to FIGS. 1 and 3, the first and second liner segments 14, 16 are configured to be substantially parallel to one another in the folded configuration 11. The third and fourth liner segments 18, 20 are configured to be substantially parallel to one another in the folded configuration 11. Referring to FIGS. 1 and 3, the third and fourth liner segments 18, 20 are configured to be substantially perpendicular to the first and second liner segments 14, 16, respectively, in the folded configuration 11.

Referring to FIGS. 3-4, the slot liner 10 is configured for insertion into a slot 30 of a stator assembly 32. FIG. 4 is a partial schematic perspective view of the stator assembly 32 of an electric machine 34. The slot 30 may be part of the stator assembly 32 or a rotor assembly (not shown) of the electric machine 34. The stator assembly 32 includes a stator stack 36 having a plurality of laminations (not shown). The slots 30 may extend entirely through the stator stack 36. The slot liner 10 defines a length “L” shown in FIGS. 1 and 2. The slot liner 10 may be pre-cut to the required length for a particular electric machine. The length L of the slot liner 10 may be selected as required by the application. The integral or one-piece configuration provides improved robustness for installation of the slot liner 10 into the slot 30.

Referring to FIG. 3, the slot 30 includes first, second and third slot walls 40, 42, 44. The first and second slot walls 40, 42 are configured to be substantially parallel to one another. Referring to FIG. 3, the first and second liner segments 14, 16 are configured to extend substantially parallel to or along the first and second slot walls 40, 42, respectively. The third liner segment 18 is configured to extend substantially parallel to or along the third slot wall 44.

Referring to FIG. 3, the first opening 26A is insulated from the first slot wall 40 by only the first liner segment 14. The first opening 26A is insulated from the second slot wall 42 by the second and fifth liner segments 16, 22. Referring to FIG. 3, the second opening 26B is insulated from the first slot wall 40 by the first and fifth liner segments 14, 22. The second opening 26B is insulated from the second slot wall 42 by only the second liner segment 16.

Referring to FIG. 3, the third opening 26C is insulated from the first slot wall 40 by only the first liner segment 14. The third opening 26C is insulated from the second slot wall 42 by the second and fifth liner segments 16, 22. Referring to FIG. 3, the fourth opening 26D is insulated from the first slot wall 40 by the first and fifth liner segments 14, 22. The fourth opening 26D is insulated from the second slot wall 42 by only the second liner segment 22.

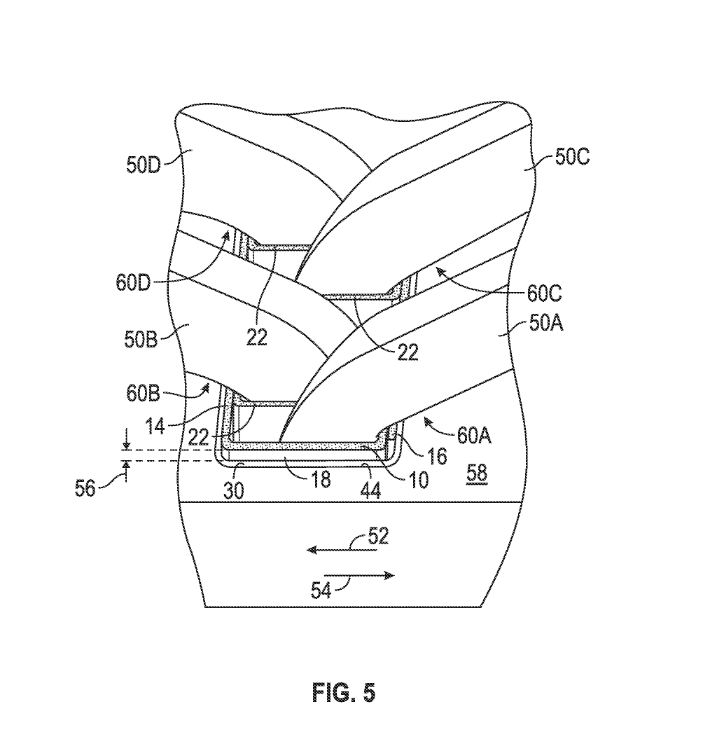

Referring now to FIG. 4, a plurality of conductors 50 are inserted into the slot 30. FIG. 5 is an enlarged schematic illustration of the portion 5 of FIG. 4. In the embodiment in FIGS. 3 and 5, the conductors 50 include first through fourth conductors 50A-D. Each of the first through fourth conductors 50A-D are threaded through respective ones of the plurality of openings 26A-D defined by the slot liner 10. Referring to FIG. 4, the conductors 50 extend from both a twist-side 46 and a crown side (not shown) of the stator stack 36.

In the embodiment shown, there are four conductors 50 per slot. The number and shape of the openings 26 (see FIG. 1) are determined by the number and shape of conductors which are to be assembled within each slot 30. The conductors 50 may be formed from a wire having a square cross-sectional shape. The number and shape of the conductors, and thus openings, may vary according to the design and purpose of the electric machine 34. In a bar wound stator assembly, the conductors 50 may be solid copper bars.

Referring to FIG. 4, the conductors 50 must be electrically isolated from the stator stack 36 to prevent phase-to-ground shorts, and from one another to prevent phase-to-phase shorts from occurring. The slot liner 10 (through the plurality of liner segments 12) electrically isolates the first through fourth conductors 50A-D (see FIGS. 3 and 5) from one another and from the respective walls 40, 42, 44 of the slot 30. Referring to FIG. 5, the slot liner 10 extends a distance 56 above the surface 58, which is the exterior-most surface of the stack 36 from the twist side 46. The distance 56 may be between about 1 to 5 mm. In one example, the distance 56 is about 3 mm. The slot liner 10 may extend entirely through the stator stack 36. Note that FIGS. 1-5 are not to scale.

Referring to FIG. 4, following the threading of the conductors 50 in the slot 30 of the stator stack 36, the conductors 50 are individually twisted into the required positions. Referring to FIG. 5, once the twist operation is complete, each of the conductors 50A-D defines a respective inwardly curved portion 60A-D. As shown in FIGS. 3 and 5, adjacent ones of the respective conductors 50A-D are twisted in substantially opposite directions. Referring to FIGS. 3 and 5, conductors 50A and 50C are twisted in a first direction 54 and conductors 50B and 50D are twisted in a second direction 52.

Referring to FIG. 5, the respective inwardly curved portions 60A-D of the conductors 50A-D are configured to be adjacent to or facing at least two of the plurality of liner segments 12 of the slot liner 10, thereby improving robustness to tears, increasing flexibility and preventing tearing of the slot liner 10 when the conductors 50A-D are pulled towards the slot liner 10 or stator stack 36. More specifically, referring to FIG. 5, the inwardly curved portion 60A of the first conductor 50A is configured to face the second and fifth liner segments 16, 22. The inwardly curved portion 60B of the second conductor 50B is configured to face the first and fifth liner segments 14, 22. The inwardly curved portion 60C of the second conductor 50C is configured to face the second and fifth liner segments 16, 22. The inwardly curved portion 60D of the second conductor 50D is configured to face the first and fifth liner segments 14, 22. This configuration increases the robustness or strength of the slot liner 10 and allows for a reduced thickness of the plurality of liner segments 12 to be employed. In one example, the thickness of each of the plurality of liner segments 12 may be reduced by approximately 50%, from approximately 0.2 mm to approximately 0.1 mm, and maintain thickness at pressure points.

The integral or one-piece configuration of the slot liner 10 minimizes wearing out of the slot liner 10 by providing a continuous insulation barrier in a repeating fashion. Additionally, the integral or one-piece configuration and repeated pattern of the slot liner 10 eliminates any possible conductor-to-conductor and conductor-to-stator shorts within a multi-layer electric machine. The slot liner 10 may composed of a paper, plastic or polymer material, or any other suitable insulating material.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A slot liner configured for insertion into a slot, the slot liner comprising:
an integral piece configured to be folded along a first set of fold lines to define a plurality of liner segments in a folded configuration;
wherein the plurality of liner segments includes first, second, third, fourth and fifth liner segments;
wherein the first and second liner segments are configured to be substantially parallel to one another in the folded configuration;
wherein the third and fourth liner segments are configured to be substantially parallel to one another in the folded configuration, the fifth liner segment extending between the third and fourth liner segments;
wherein the fifth liner segment is configured to be folded along a second set of fold lines to define a plurality of openings, the plurality of openings including a first opening.

2. The slot liner of claim 1, wherein:
the third and fourth liner segments are contiguous with the first and second liner segments, respectively;
the third and fourth liner segments are configured to be substantially perpendicular to the first and second liner segments, respectively, in the folded configuration.

3. The slot liner of claim 1, wherein:
the slot includes first, second and third slot walls, the first and second slot walls being substantially parallel to one another;
the first opening is insulated from the first slot wall by only the first liner segment; and
the first opening is insulated from the second slot wall by the first and fifth liner segments.

4. The slot liner of claim 3, wherein:
the first and second liner segments are configured to extend substantially parallel to the first and second slot walls, respectively; and
the third liner segment is configured to extend substantially parallel to the third slot wall.

5. The slot liner of claim 3, wherein:
the plurality of openings include a second opening adjacent to the first opening;
the second opening is insulated from the first slot wall by the first and fifth liner segments;
the second opening is insulated from the second slot wall by only the second liner segment.

6. The slot liner of claim 5, wherein:
the plurality of openings includes a third opening adjacent to the second opening;
the third opening is insulated from the first slot wall by only the first liner segment; and
the third opening is insulated from the second slot wall by the second and fifth liner segments.

7. The slot liner of claim 6, wherein:
the plurality of openings includes a fourth opening adjacent to the third opening;
the fourth opening is insulated from the first slot wall by the first and fifth liner segments;
the fourth opening is insulated from the second slot wall by only the second liner segment.

8. The slot liner of claim 1, wherein a thickness of each of the plurality of liner segments is approximately 0.1 mm.

9. The slot liner of claim 1, in combination with a respective plurality of conductors configured to be respectively inserted in the plurality of openings.

10. The slot liner of claim 9, wherein:
each of the respective plurality of conductors are configured to be twisted to define respective inwardly curved portions; and
adjacent ones of the respective plurality of conductors are configured to be twisted in substantially opposite directions.

11. The slot liner of claim 10, wherein the respective inwardly curved portions of the respective plurality of conductors are configured to face at least two of the plurality of liner segments.

12. An electric machine comprising:
a stator assembly including a stator stack and defining at least one slot extending through the stator stack;
wherein the at least one slot includes first, second and third slot walls, the first and second slot walls being substantially parallel to one another;
a one-piece slot liner configured to be folded along a first set of fold lines to define a plurality of liner segments in a folded configuration, the plurality of liner segments including first, second, third, fourth and fifth liner segments;
wherein the first and second liner segments are configured to be substantially parallel to one another in the folded configuration;
wherein the third and fourth liner segments are configured to be substantially parallel to one another in the folded configuration, the fifth liner segment extending between the third and fourth liner segments;
wherein the fifth liner segment is configured to be folded along a second set of fold lines to define a plurality of openings, the plurality of openings including a first opening;
wherein the first opening is insulated from the first slot wall by only the first liner segment; and
wherein the first opening is insulated from the second slot wall by the second and fifth liner segments.

13. The machine of claim 12, wherein:
the third and fourth liner segments are contiguous with the first and second liner segments, respectively;
the third and fourth liner segments are configured to be substantially perpendicular to the first and second liner segments, respectively.

14. The machine of claim 12, wherein:
the plurality of openings include a second opening adjacent to the first opening;
the second opening is insulated from the first slot wall by the first and fifth liner segments;
the second opening is insulated from the second slot wall by only the second liner segment.

15. The machine of claim 14, wherein:
the plurality of openings includes a third opening adjacent to the second opening;
the third opening is insulated from the first slot wall by only the first liner segment; and
the third opening is insulated from the second slot wall by the second and fifth liner segments.

16. The machine of claim 15, wherein:
the plurality of openings includes a fourth opening adjacent to the third opening;
the fourth opening is insulated from the first slot wall by the first and fifth liner segments; and
the fourth opening is insulated from the second slot wall by only the second liner segment.

17. The machine of claim 15, further comprising:
a respective plurality of conductors configured to be inserted in the plurality of openings;
each of the respective plurality of conductors are configured to be twisted to define respective inwardly curved portions; and
adjacent ones of the respective plurality of conductors are configured to be twisted in substantially opposite directions.

18. The machine of claim 17, wherein the respective inwardly curved portions of the respective plurality of conductors are configured to face at least two of the plurality of liner segments.
